(19) United States
(12) Patent Application Publication
(10) Pub. No.: US 2026/0252479 A1
(43) Pub. Date: Aug. 27, 2026

(54) Software Environment Transition System and Method of Use

(71) Applicant: Worcester Polytechnic Institute, Worcester, MA (US)

(72) Inventors: Adam Beauchaine, Worcester, MA (US); Craig A. Shue, Worcester, MA (US)

(73) Assignee: Worcester Polytechnic Institute, Worcester, MA (US)

(21) Appl. No.: 19/536,006

(22) Filed: Feb. 10, 2026

Related U.S. Application Data
(60) Provisional application No. 63/756,655, filed on Feb. 10, 2025.

(51) Int. Cl. G06F 11/3698; G06F 8/65

(52) U.S. Cl. CPC G06F 11/3698; G06F 8/65

(57) ABSTRACT

Embodiments of the innovation relate to, in client device, a method for transitioning a first environment of a client device to a second environment. The method comprises receiving a first disk image to create the first environment executed, and displayed to an end-user, by the client device and a second disk image to create the second environment executed by the client device and identifying a change to the first environment. The method also comprises updating the second environment with the identified change to the first environment and swapping the second environment with the first environment, the second environment displayed to the end-user by the client device. As such, the client device provides for the real-time testing and evaluation of software updates in an environment directly subjected to a real user workflow, as well as an ease of migration to the client device when a user decides to update their software.

### RELATED APPLICATIONS

This patent application claims the benefit of U.S. Provisional Application No. 63/756,655 filed on Feb. 10, 2025 and entitled “Software Update System with Downtime Mitigation,” the contents and teachings of which are hereby incorporated by reference in their entirety.

### BACKGROUND

The software development process typically involves planning, designing, building, testing, and maintaining applications, with each stage aimed at delivering reliable and functional software to users. Despite careful design and testing, defects can be inevitable because software systems are complex and must operate across varied environments, user behaviors, and hardware configurations. As these defects are discovered, such as through user reports, monitoring, or ongoing testing, developers typically deploy patches to correct the errors and to improve performance or stability.

Software updates are a critical component of modern information systems. For example, regular patching of updates is essential to ensure the software continues to function as intended, protects users from potential risks, and adapts to changing technical requirements over time. As such, rapidly deployment of security patches within an organization's information system can reduce the risk of adversaries exploiting vulnerabilities. With conventional software update deployment, organizations can utilize complex test environments or testbeds to deploy the software updates or can deploy the updates to smaller segments of a larger production network, in a process known as staggered deployment.

### SUMMARY

While software updates are a crucial aspect to information system management, conventional software development and update deployment mechanisms suffer from a variety of deficiencies.

For example, software developers need time and resource-efficient methods for performing software validation testing. Despite the rapid rise of AI programming tools allowing for faster output of software, automated software validation strategies continue to leverage script-based artifacts. The functionality of such artifacts is often fragile with respect to software updates, especially in cases where significant front-end changes to a graphical application occur. These factors often lead to validation testing becoming a bottleneck relative to code production in the software development pipeline.

Further, absent defect-free software development, software patches represent a critical component in ensuring that an organization's information system is both stable and secure. For example, conventional best practice is for an organization to deploy software updates as quickly as possible. However, patches that are rushed out without thorough testing can wreak havoc. For example, in some cases, the updates may interfere with system functionality or inadvertently introduce new security vulnerabilities.

One conventional approach to mitigate this problem, from an organizational level, includes leveraging testing environments. However, existing testing environments are largely configured manually and highly prone to errors. Another conventional approach involves an initial deployment of the software updates to smaller segments of a production network (staggered deployment). A staggered approach allows for some risk mitigation, but takes longer to orchestrate and allows for patch vulnerabilities to affect production systems.

Further, an organization can use hot patching to modify, replace, or update software components while a system is running, without requiring a restart or downtime. However, hot patching can increase system complexity and can complicate debugging because the running state may differ from what is defined at startup. It can also introduce subtle consistency or compatibility issues if new components do not perfectly align with an existing in-memory. Hot patching may, thus, be limited in the types of updates it can feasibly employ.

Additionally, the challenges associated with software update deployment can extend to end users. Users are often hesitant to deploy updates due to concerns about productivity impacts. For example, when deploying updated software, the end-user experience can be negatively affected due to downtime requirements. Further when updating is discretionary, users will often avoid installing software updates due to downtime and the resulting productivity impacts.

By contrast to conventional software update deployment mechanisms, embodiments of the present innovation relate to a software environment transition system and a method of use.

In one arrangement, a server device of the software environment transition system is configured to access a disk image database and create a first disk image and a second disk image, each associated with a client device profile of a client device and provide these disk images to the client device. The client device can run the first disk image as a first environment in the foreground, as presented to an end user, and can run the second disk image as a second environment in the background. As an end-user interacts with the first environment, the client device can record changes to the first environment as store these changes as part of an action log. While the second disk image can serve as a backup to the first disk image, the client device can be configured to modify the second disk image with a software update and to test the functionality of the resulting second environment. The client device is also configured to record user events and system events related to the environment of the client device. After a given time period, the client device is further configured to apply one or more of the recorded changes to the second environment to simulate the user's workflow in the first environment in real-time and can swap the first environment with the second environment.

In this approach, the client device can be configured to provide for the real-time testing and evaluation of software updates in an environment directly subjected to a real user workflow. In this approach, the client device also provides an environment, the second environment, that a user may swap over to using once it is deemed to be acceptable for usage (i.e., first and second environments are swapped, as opposed to updating the unpatched environment of the client device). Accordingly, use of the client device provides an ease of transition for software updates to the client device which minimizes workflow disruption. Further, the unpatched first environment utilized by the client device can also serve as a fallback environment, if a return to the unpatched state is desired by the user (e.g., a backup system for rollbacks and workflow restoration across images).

Embodiments of the innovation relate to, in client device, a method for transitioning a first environment of a client device to a second environment. The method comprise receiving a first disk image to create the first environment executed, and displayed to an end-user, by the client device and a second disk image to create the second environment executed by the client device and identifying a change to the first environment. The method also comprises updating the second environment with the identified change to the first environment and swapping the second environment with the first environment, the second environment displayed to the end-user by the client device.

Embodiments of the innovation relate to a client device comprising a controller having a processor and a memory. The controller is configured to receive a first disk image to create the first environment executed, and displayed to an end-user, by the client device and a second disk image to create the second environment executed by the client device and to identify a change to the first environment. The controller is also configured to update the second environment with the identified change to the first environment and swap the second environment with the first environment, the second environment displayed to the end-user by the client device.

### BRIEF DESCRIPTION OF THE DRAWINGS

The foregoing and other objects, features and advantages will be apparent from the following description of particular embodiments of the innovation, as illustrated in the accompanying drawings in which like reference characters refer to the same parts throughout the different views. The drawings are not necessarily to scale, emphasis instead being placed upon illustrating the principles of various embodiments of the innovation.

FIG. 1 illustrates a block diagram of a software environment transition system having a client device, according to one arrangement.

FIG. 2 illustrates a flowchart of a method performed by the client device of FIG. 1, according to one arrangement.

FIG. 3 illustrates a block diagram of a software environment transition system having a client device configured to harvest user interface (UI) data, according to one arrangement.

FIG. 4 illustrates a block diagram of a software environment transition system having a client device configured to harvest application data, according to one arrangement.

FIG. 5 illustrates an arrangement of a client device configured to execute a heuristic approach, according to one arrangement.

### DETAILED DESCRIPTION

Embodiments of the present innovation relate to a software environment transition system and a method of use. In one arrangement, a software environment transition device of the software environment transition system can be configured to dynamically construct test environments of end-user or client devices on a per-user basis, such as by utilizing commercial backup, networked file storage, and imaging automation systems. For example, the software environment transition device can clone an environment of a networked client device and can execute this environment, along with a software update or patch, as an updated environment in real time. As this occurs, the end-user can continue to use the unpatched environment as part of the client device. The environment transition device is also configured to record system events, such as user inputs, related to the environment of the client device. For example, the software environment transition device can execute one or more user interface (UI) sensors to record data generated in the unpatched environment executed by the client device. The software environment transition device can apply the recorded data to the updated environment to simulate the user's workflow in the unpatched environment in real-time and can transition this final environment to the client device.

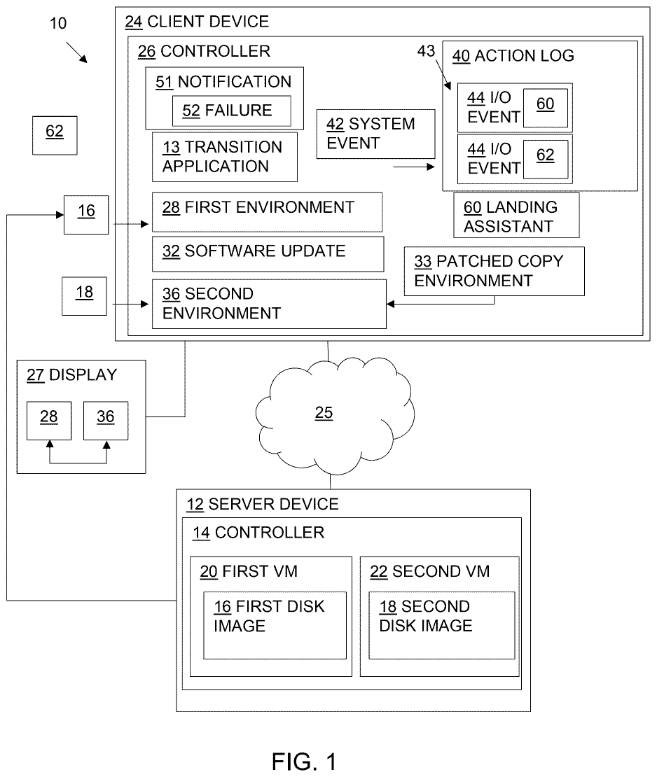

FIG. 1 illustrates a block diagram of a software environment transition system 10, according to one arrangement. The software environment transition system 10 can be configured in a variety of ways. For example, the software update system 10 can be configured as a local area network (LAN), such as within an enterprise or organization. In another example, the software update system 10 can be configured as a wide area network (WAN), such as across multiple enterprises (e.g., the Internet).

The software environment transition system 10 includes a set of network resources, such as one or more client devices 24, disposed in electrical or optical communication with a server device 12 through a network 25.

The server device 12 is configured as a computerized device including a controller 14, such as a memory and a processor, configured with a software environment transition application 13. During operation, the server device 12 is configured to access a disk image database, such as a commercial backup system retained by an organization via a deployment server device, and create a first disk image 16 and a second disk image 18, each associated with a client device profile of the client device 24. In one arrangement, the second disk image 18 is configured as a backup to the first disk image 16. In one arrangement, the second disk image 18 includes a software patch or update. During bootup of the client device 24, the server device 12 can provide a first virtual machine 20, which executes the first disk image 16, and a second virtual machine 22 which executes the second disk image 18 to the client device 24. This allows the client device 24 to run multiple operating systems or isolated environments on a single physical computer.

The server device 12 can provide the first and second virtual machines 20, 22 to the client device 24 for variety of scenarios. For example, the server device 12 can provide the second virtual machine 22 as a fallback state or backup to the first virtual machine 20 for the client device 24, in the event of a client device 24 failure. In another example, as will be described below, the server device 12 can provide the second virtual machine 22 for the purpose of testing a software update or patch by the client device 24.

In one arrangement, each client device 24 is configured as a computerized device, such as a laptop or personal computer, having a controller 26, such as a memory and a processor, configured with a software environment transition application 13. When the controller 26 of client device 24 executes the software environment transition application 13, the client device 24 is configured to transition a first environment 28 associated with the first disk image 16 to a second environment 36 associated with the second disk image 16.

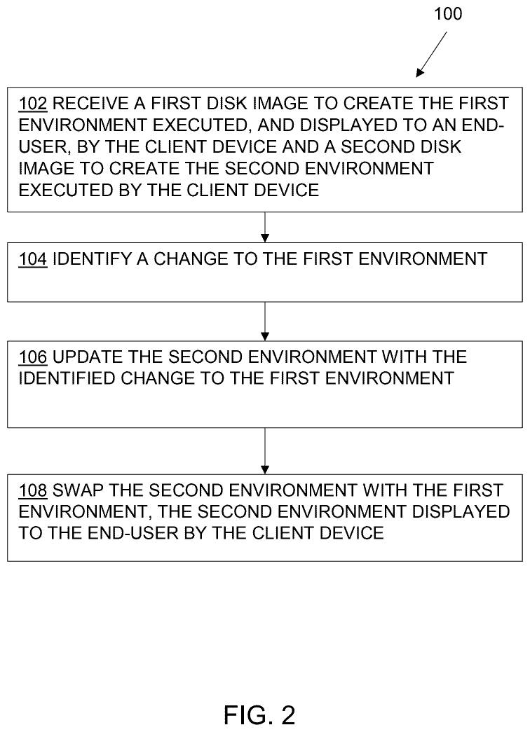

FIG. 2 illustrates a flowchart 100 of a method performed by the controller 26 of the client device 24 during the transitioning process of FIG. 1, according to one arrangement.

In element 102, the client device 24 is configured to receive a first disk image 16 to create a first environment 28, executed and displayed to an end-user, by the client device and a second disk image 18 to create the second environment 36 executed by the client device. For example, the server device 12 can provide the first disk image 16 to the client device 24 as part of a first virtual machine 20 and can provide the second disk image 18 to the client device 24 as a second virtual machine 22. The client device 24, in turn, is configured to dynamically construct the first environment 28 from the first disk image16 and the second environment 36 from the second disk image 18. While the client device 24 can run both the first and second environments 28, 36 in parallel, the client device 24 can provide the first environment 28 to an end user via a display 27, while maintaining the second environment 36 in the background (i.e., not provided to the end user via display 27).

The first environment 28 can be configured in a variety of formats. For example, the first environment 28 can be configured as a desktop environment, such as a graphical user interface (GUI), that includes the visual elements (e.g., icons) and tools (e.g., taskbars) that allows a user to interact with the client device 24. In another example, the first environment 28 can be configured as an operating environment or host operating system that directly manages physical hardware associated with the client device 24 to run software applications.

In element 104, the client device 24 is configured to identify a change to the first environment 28. For example, following generation of the second environment 36, a user of the client device 24 can continue to interact with, and make changes to, the first environment 28. As such, in the case where the changes to the first environment 28 relate to a system event 42 occurring with the client device 24, the client device 24 is configured to identify tasks 43 related to these system events 42 and to record the tasks 43 into an action log 40.

The system event 42 can be configured in a variety of ways, such as any type of data or interaction event associated with the client device. For example, the system event can be a user input associated with the first environment 28, such as the updating of a document by an end user or any input event initiated by the end-user (i.e., mouse click, keyboard stroke, etc.). In another example, the system event 42 can be a software and/or operating system event, such as a system startup, shutdown, or restart. In another example, the system event 42 can be a security event, such as a user logon or logoff. In another example, the system event 42 can be an input/output event 44, such as a network connection being established or dropped by the client device 24 a data packet being transmitted or a VPN connection starting or ending.

In one arrangement, as the client device 12 identifies changes to the first environment 28, the client device 12 can utilize the second environment 30 to test the functionality of a software update or patch associated with the client device 24.

For example, as provided above, in the case where a software update or patch is to be tested for operability with the client device 24, a systems administrator can include the software patch or update 32 as part of the second disk image 18 transmitted to the client device 24. In another example, the server device 12 can provide identical first and second disk images 16, 18 to the client device 24 and the client device 24 can retrieve and apply the software update to the second disk image 18. For example, with execution of the transition application 13, the client device 24 can then retrieve the software update 32 from a trusted source or patch server and can apply a software update or patch 32 to the second disk image 18 to generate a patched disk image 33. For example, the client device 24 can update the second disk image 18with new files or instructions that replace code of the second disk image 18, add new code alongside existing code of the second disk image 18, or remove code from the second disk image 18 to generate the patched disk image 33.

Next, the client device 24 can test functional operation of the second environment 36. For example, the client device 12 can execute the patched disk image 33 to generate the second environment 36 which includes the software update 32. Further, the client device 24 can execute a script to check that core features of the second environment 36 work end-to-end or to ensure that user workflows complete successfully. In the case where the software update 32 fixes a vulnerability, the client device 24 can verify that the vulnerability no longer works or that no new security issues were introduced within the second environment 36. The client device 12 can conduct the testing of the update 32 while the client device 24 continues to utilize the first environment 28, independent from the update and testing process.

Returning to FIG. 2, in element 106, the client device 24 is configured to update the second environment 36 with the identified change to the first environment 28. For example, in the case where the client device 24 generates the patched disk image 33, in response to detecting functional operation of the second environment derived from the patched disk image 33, the client device 24 is configured to update the second environment 36. with the identified change to the first environment 28. For example, the client device 12 can retrieve tasks 43 related to system events 42 from the action log 40 and can apply those tasks 43 to the second environment 36. With such application, the client device 12 can update a state of the second environment 36 such that it corresponds with the current state of the first environment 28.

In one arrangement, the second environment 36 is configured as a functional equivalent to the first environment 28 such that a user can perceive differences, such as differences to a familiar interface related to the user experience, but those differences are irrelevant with respect to usability. For example, as the client device 24 tracks changes to the first environment 28, certain changes may provide different visual grounding between the first and second environments 28, 36. However, these differences are deemed immaterial by the client device 24. As such, when preparing the second environment 36 from the contents of the action log 40, relatively minor changes to the display of the second environment 36 by the client device 24 can be detected by the user. However, based upon the tasks 43 associated with the client device 24 and maintained by the action log 40, the client device 24 can generate the second environment 36 as having a core functionality (e.g., having a set of software behaviors and/or state operations that work to allow the second environment 36 to fulfill its primary purpose) that corresponds (e.g., operates in a manner that is the same or identical) to a core functionality of first environment 28.

In element 108, the client device 24 is configured to swap the second environment 36 with the first environment 28, the second environment 36 displayed to the end-user by the client device 24. For example, following generation of the second environment 36, the client device 24 is configured to execute a landing assistant 60 to identify an appropriate time to swap the second environment 36 as a replacement for the first environment 28. In one arrangement, the landing assistant 60 is configured to determine if the second environment 36 is synchronized with the first environment 28. Absent a synchronization between the two environments 36, 28, the landing assistant 60 can cause the client device 24 to further revise the second environment 36 to include additional or updated tasks 43 associated with system events 42 from the action log 40. Also, the landing assistant 60 can look for an opportune time to swap the first environment 28 with the second environment 36 to the client device 24, such as when the end user has not interacted with the client device 24 for a given period of time or upon meeting some set of requirements (e.g., a set of applications are closed by the user).

In one arrangement, the client device 24 can perform the swap or cut-over of the first environment 28 with the second environment 36 while a user interacts with the client device 24. In such a case, the client device 24 can provide a notification to the end user, such as through the display of pop-up window identifying the cut-over event. In one arrangement, the client device 24 can perform the swap or cut-over event when the client device 24 is idle (i.e., minimal or no interaction with the end user).

In one arrangement, following the swap event, the client device 24 is configured to provide a level of failure-recovery by tracking the operation of the second environment 36. For example, the second environment 36 can be configured with certain instrumentation to provide notifications 50 to the client device 24 regarding its operation, such as logs which provide discrete event notifications (e.g., “started task X”, “error Y occurred”).

In response to detecting a failure 52 of operation of the second environment 36, or when ordered by the user, the client device 24 is configured to replace the second environment 36 with the first environment 28. For example, assume the case where the second environment 36 includes, within a log notification 50, that an error had occurred 52 with its operation. In response to receipt of the notification, the client device 24 is configured to swap the updated second environment 36 with the previous first environment 28 to provide continuous operation of the client device 24. In the event that the client device 24 fails to receive a notification of the failure 52 of operation of the second environment 36 after a given period of time, the client device 24 is configured to identify the second environment 36 as being functional and to delete the first environment 28.

As provided above, the server device 12 is configured to provide a first disk image 16, such as executed by a first virtual machine 20, and a second disk image 18, such as executed by a second virtual machine 22, to the client device 24, such as to provide a fallback state or backup for the client device 24, in the event of a client device 24 failure. In this approach, the client device 24 can track changes to a first environment 28 associated with the first virtual machine 20 and apply those changes to a second environment 36 associated with the second virtual machine 22 as a backup environment to the client device 24. Further, in one arrangement, the client device 24 is configured to dynamically construct a patched disk image 33 based on the first disk image 16 in order to test and evaluate software updates within the system 10 in real-time and in an environment directly subjected to a real user workflow. Accordingly, use of the client device 24, as configured with the software environment transition application 13, can provide an ease of transition for software updates 32 to the client device 24 while minimizing workflow disruption. Further, the unpatched first environment 28 can also serve as a fallback, if a return to the unpatched state is desired by the user (e.g., a backup system for rollbacks and workflow restoration).

As provided above, when the controller 26 of the client device 24 executes the software environment transition application 13, the client device 24 is configured to record one or more tasks 43 associated with the client device 24 into the action log 40. In one arrangement, the client device 24 is configured to record one or more user interface events 50 associated with the first environment 28 of the client device 24.

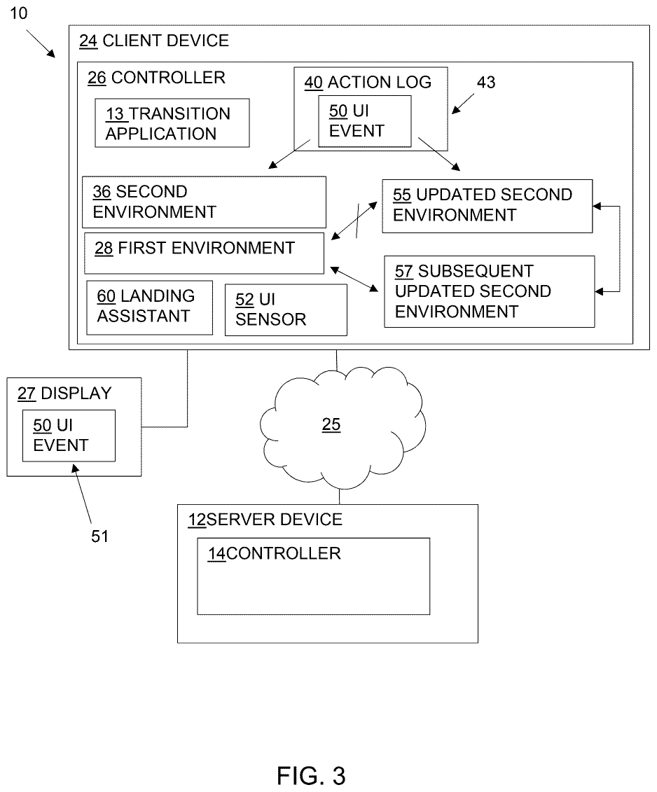

For example, as indicated in FIG. 3, when the software environment transition application 13 is executed by the controller 26 of the client device 24, the client device 24 is configured to record user interface (UI) event data 50 associated with a user interface or 51 providing a first state or first environment 28 of the client device 24. The user interface 51 of the first environment 28 can be configured in a variety of formats. For example, the user interface 51 can be configured as a graphical user interface (GUI), that includes the visual elements (e.g., icons) and tools (e.g., taskbars) as provided by the client device 24 on the display 27. The UI event data 50 can relate to changes to the user interface 51 as a result of an end user's interaction with the client device 24. For example, as a user edits a document or updates a window associated with the first environment 28, these changes result in a change in the user interface 51 displayed by the display 27.

In one arrangement, the client device 24 can dynamically record a user interface image 51 associated with the first environment 28, such as by utilizing conventional, commercially-available backup, network file storage, and imaging automation systems. For example, with these systems, the client device 24 can record a UI image 51 of the first environment 28, such as the pixel display of the client device 24 as provided on display 27. Further, the controller 26 of the client device 24 can store this image 51 as a user interface event 50 with the action log 40 in real time while an end-user continues to interact with the first environment 28 as part of the client device 24.

Following recordation of UI event data 50 associated with the first environment 28 by the client device 24, a user of the client device 24 can continue to interact with, and make changes to the first environment 28. As such, the client device 24 is configured to identify particular changes to the user interface, and to record UI events 50 associated with those changes into the action log 40. For example, as the client device 24 executes the first environment 28, the client device 24 can then execute one or more user interface (UI) sensors 34 to record user workflow data associated with the first environment 28. For example, the UI sensor 34 can record visual data generated in the first environment 28 executed by the client device 24 as user-interface events 50 and can store these user-interface events 50 in the action log 40.

In one arrangement, the client device 24 is configured to utilize various visual grounding methods with the UI sensors 52. A grounding method is a formal process for the transposition of user interface visual data to a structured data that may be interfaced with by an agent. The client device 24 can deploy a reinforcement learning agent that learns based on data provided by computer vision-based or other grounding of images, as well as by other system representation grounding of the UI, such as by UI accessibility grounding of system states.

The client device 24 can simulate, in the second environment 36, real-time user workflow in the client device 24 based upon the recorded user-interface events 50 stored in the action log 40. By updating the second environment 36 with the recorded data 50 from the UI sensor 34, the client device 24 can generate an updated second environment 55 that mirrors the user's interaction with the first environment 28 on the client device 24.

The client device 24 is configured perform such a process iteratively to provide a match between the updated second environment 55 and the first environment 28. For example, the client device 24 can retrieve the oldest (i.e., first recorded) user-interface event 50 from the action log 40 and can apply it to the UI image of the second environment 36 to generate an updated second environment 55. The client device 24 can then compare the updated second environment 55 to the first environment 28 to determine if the updated second environment 55 corresponds with or matches the first environment 30.

Assume the case where the client device 24 detects a lack of correspondence between the updated second environment 55 and the first environment 30. In such an instance, the client device 24 is configured to repeat the steps of retrieving a subsequently recorded user-interface event 50 from the action log 40 and applying the user interface event 50 to the updated second environment 55 to generate a subsequent updated second environment 57. The client device 24 can then compare the subsequent updated second environment 57 to the first environment 28 executed by the client device 24.

In the case, after one or more iterations, where the client device 24 detects a match between the subsequent updated second environment 57 and the first environment 28, the client device 24 is configured to execute a landing assistant 60 to identify an appropriate time to swap the subsequent updated second environment 57, as the second environment 36as a replacement for the first environment 28. For example, the landing assistant 60 can determine if the second environment 36 is synchronized with the first environment 28. Absent a synchronization between the two environments 36, 28, the landing assistant 60 can cause the client device 24 to further revise the second environment 36 to include additional recorded data from the UI sensor 34. Also, the landing assistant 60 can identify an opportune time to swap the first environment 28 with the second environment 36, such as when the end user has not interacted with the client device 24 for a given period of time or when a set of requirements are met (e.g., the user closes a set of applications).

In one arrangement, when the client device 24 cannot exactly replicate states between the second environment 36 and the first environment 28, the client device 24 is configured to utilize a virtual desktop interface (VDI) technique to provide synchronization. For example, assume the case where the client device 24 displays a VDI window of a virtual machine instance associated with first environment 28. The client device 24 can create a VDI window of a virtual machine instance associated with second environment 36 and can track the end user's interaction with the VDI window of first environment 38. During operation, the end user of the client device 24 can adjust the first environment 28, such as by closing applications executed by the client deice 24 that cannot be effectively synchronized between the second environment 36 and the first environment 28. With this adjustment, in response to detecting a correspondence between the VDI window of first environment 38 with the VDI window of second environment 36, the client device 24 can perform a cut-over event to toggle the VDI window of first environment 28 from the foreground of the display 27 to the background and toggle the VDI window of second environment 36 from the background of the display 27 to the foreground.

As such, the client device 24 is configured to provide an environment, the second environment 36, that a user may swap over to using once it is deemed to be acceptable for usage (i.e., environments are swapped, as opposed to updating the unpatched environment of the client device). Accordingly, use of the client device 24 provides an ease of transition for software updates 32 to the client device 24 which minimizes workflow disruption. Further, the original, first environment 28 utilized by the client device 24 can also serve as a fallback environment, if a return to the unpatched state is desired by the user (e.g., a backup system for rollbacks and workflow restoration across images).

In one arrangement, the client device 24 is configured to label tasks 43 related to these system events 42, such as I/O events 44, user events, and/or user interface events 50, for the purposes of storing and re-creating user workflows across devices. This allows for functional state replication of endpoint machines, which is useful for a wide range of purposes. Tasks 43 associated with system events 54 can be stored in the action log 40 as a queue data structure (first in, first out), for the purpose of being analyzed and replayed by another device. In one arrangement, each task 43 43 associated with a system event 54 can include one of two labels: replayability 60 and skippability 62.

Replayability refers to whether an event 50 can be replayed. This is true for most actions taken in local applications such as word processing, file management, or games. Network activities are the main cause of a task 43 associated with a system event 54 becoming non-replayable. These activities involve application states across a distributed system and thus are difficult to replicate between machines. Non-replayable events can include networked applications (e.g., Firefox, Outlook, RDP) that can require a network state and hardware-dependent workflows (e.g., USBs, printers, and 2FA dependent workflows). In response to detecting a replayability label 60 associated with a task 43 of a system event 54, the client device 24 is configured to update the second environment 36 with the replayable task from the action log 40.

Skippability refers to whether a task 43 associated with a system event 54 can be skipped. To give an example, if a user has saved some data, the tasks associated with a system event 54 that produced that data may be skipped safely, since the file already exists in a saved state. In one arrangement, when associated with the same process, if a task associated with a system event 54 0 is enclosed within an initialization and write action, it may be skipped. In response to detecting a skippability label 62 associated with a task 43 of a system event 54, the client device 24 is configured to refrain from updating the second environment 36 with the skippable task from the action log 40.

In other examples, navigation actions are skippable, unless performed inside an initialization and de-initialization block. Further, initialization actions are skippable if mapped to a matching deinitialization action, and both exist before a write action. Additionally, transformation actions are typically not skippable, unless they exist before a write action, in which case they are skippable and write actions are skippable.

As provided above, when the controller 14 of the client device 24 executes the software environment transition application 13, the client device 24 is configured update the second environment 36, such as following the application of a software patch to an associated second disk image, with an identified change to the first environment 28. In one arrangement, the client device 24 is configured to update a state of an application executed within the first environment 28 of the client device 24 with a copy of the application executed within the second environment 36 of the client device 24.

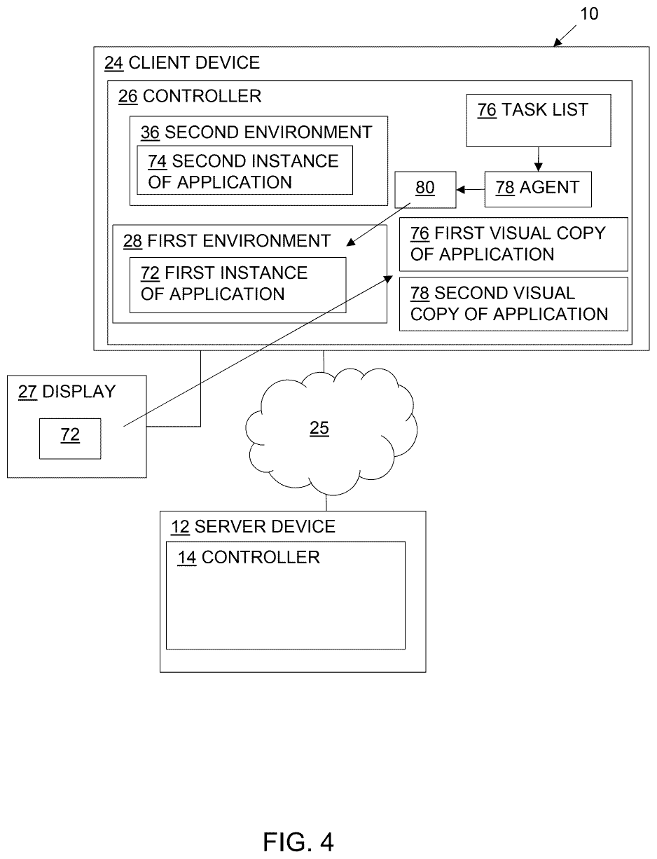

In one arrangement, with reference to FIG. 4, during operation, the client device 24 is configured to execute a first instance of an application 72 within the first environment 28 and a second instance 74 of the application in the second environment 36. The client device 24 can present the first instance of the application 72 to an end user through display 27. Further, the client device 24 can retain the second instance of the application 74 within the second environment 36 in order to perform a test on the application 74 following application of a software patch.

In order to ensure a seamless replacement of the first instance of the application 72 with the second instance of the application 74 following testing, the client device 24 is configured to create a first visual copy 76 of the application 72 executed by the client device in the first environment 28. For example, in the case where the client device 24 executes a word processing application 72, the client device 24 can capture, as the first visual copy 76, an image of a word processing document edited by an end user, such as via a screen capture mechanism.

In the case where the client device 24 is tasked with transitioning the second instance of the application 72 (e.g., the patched or updated instance of the application), the client device 24 is configured to identify a change to the first instance of the application 72 executed by the client device 24 over time. For example, over time, the end user can change the state of the first instance of the application 72, such as, in the case of a word processing application 72, by adding or subtracting words and or images to the word processing document. As such, the client device 24 is configured to create a second visual copy 78 of the application 72 executed by the client device in the first environment 28. For example, following user interaction with the application 72, the client device 24 can perform a screen capture of an image the application 72, such as provided by display 27 and can retain this image as the second visual copy 78 of the application 72. Further, to identify changes to the application 72, the client device 24 is configured to compare the first visual copy 76 of the application 72 with the second visual copy 78 of the application 72. With such a comparison, the client device 24 can identify additions to or deletions from the word processing document.

As a result of identifying differences, the client device 24 is configured to generate a task list 76 identifying one or more steps to transition a state 74 of the second instance 74 of the application 72 to the state of the first instance of the application 72 executed by the client device 24. A task list refers to a set of UI atomic actions (e.g., clicking, typing) that produce a given state output when executed in sequence. For example, the client device 24 can generate, as the task list 76 a distinct start and goal state of the application 70 along with a list of steps to replicate the goal state from the start state.

Next, the client device 24 can apply the one or more steps of the task list 76 to transition the state of the second instance of the application 74 to the current state of the first instance of the application executed by the client device 24. For example, the client device 24 can provide the task list 76 to an agent 78, such as a large language model, in JSON format. Based upon the task list 76, the agent 78 can generate a transitioned the second instance of the application 80 which the client device 24 can use as a replacement for the first instance of the application. The client device 24 can then swap the transitioned second instance of the application 80 for the first instance 74 of the application 72 executed by the client device 24.

In one arrangement, the client device 24 is configured to provide a heuristic-based approach to application testing. For example, the client device 24 is configured to leverages stateful GUI information associated with an application, as well as natural language signals as heuristic indicators of a state replication path. Due to the usage of textual heuristic indicators, no screenshot representations of the UI are leveraged for the heuristic algorithm. Instead, Document Object Model (DOM) element trees serve as the basis for the approach.

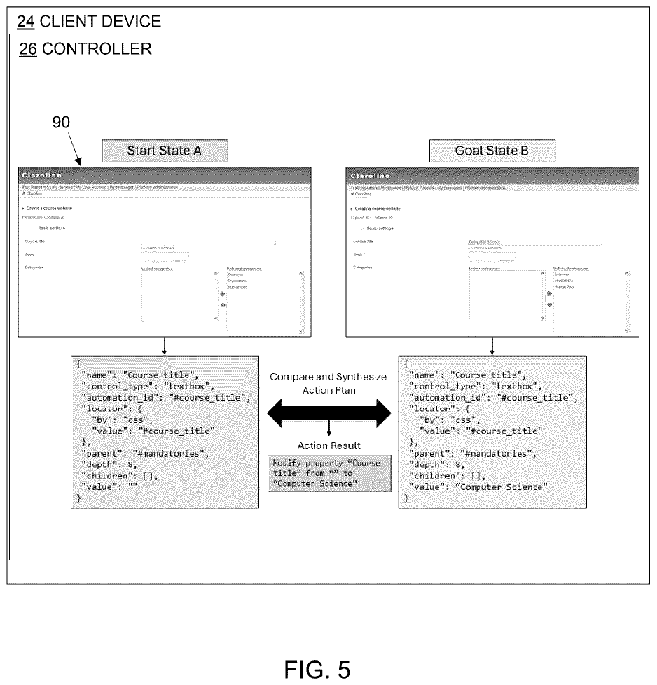

FIG. 5 illustrates an arrangement of a client device 24 configured to execute the heuristic approach. For example, the client device 24 is configured to DOM trees are produced from a live web page 90 and contain an ordered collection of nodes. Nodes encode a normalized control type (e.g., textbox, button, link, checkbox/radio, combobox), stable locators (CSS selectors), and lightweight state properties (e.g., toggle state, selected state, value). Nodes further contain a set of natural language data in both the “name” and “value” fields, depending on the specific representation.

The client device 24 proceeds in an iterative loop up to a maximum limit. At each iteration the client device 24 generates a snapshot of a current DOM tree, computes a UI similarity score with the goal state, and develops a plan of atomic actions to perform in order to reach the goal state. The iteration concludes when the client device 24 executes all actions within this plan have been executed.

One edge case to consider is the scenario in which the client device 24 actuates a node that alters the state of DOM tree, and renders other nodes inaccessible (such as clicking a link to a new web-page.) In such a case that this occurs and the new UI tree is not the goal state, the client device 24 cannot continue with its previous plan. To address this, several remediation actions are attempted by the client device 24. For example, the client device 24 can first attempt to navigate back to the initial state of the interaction, either by clicking a back button in a browser, or clicking items associated with the prior state. If this fails, the client device 24 can restart the entire application or reload the page in order to proceed from scratch. In this case, the attempted action that caused the prior sequence of events is removed from future consideration.

In one arrangement, the client device 24 is configured to execute a two-mode action controller designed to represent a natural approach for conducting a heuristic search across UI states. The selection of these modes by the client device 24 is based on the current similarity to the goal UI state. For example, a first mode, wilderness mode, is used when there are significant differences between the start and goal states. A second mode, proximity mode is used when current state is relatively similar to the goal state. Precisely, mode selection is based on a given similarity threshold with the goal state, which may be tuned for specific problems. If the current similarity is greater than this threshold, proximity mode is used, otherwise, wilderness mode is used.

In wilderness mode, the client device 24 generates a wilderness plan by traversing the goal tree and identifying “actionable gaps” that are absent or weakly matched in the current DOM tree. Candidate actions are then ranked using natural-language signals such as node text/name, accessibility attributes, and keyword heuristics. These are further combined with lightweight structural cues such as control type, locator stability for a weighted average, with natural language similarities to a goal state receiving the highest weighting. The highest-scoring candidates are then executed in order of these weights. When navigating graphical systems, users rely on “information scent” in the form of textual and structural cues that predict whether an action will lead toward their goal. Conventionally, information scent strongly influences the paths users follow during web interaction, and that weakening scent commonly triggers backtracking or shifts to alternative navigation strategies. Accordingly, Wilderness mode ranks candidate UI actions by the semantic similarity between goal-relevant text and available UI cues. This may result in an exhaustive search of nodes in the worst case that the client device 24 can find no similar nodes in a tree, though this was never encountered in testing.

While various embodiments of the innovation have been particularly shown and described, it will be understood by those skilled in the art that various changes in form and details may be made therein without departing from the spirit and scope of the innovation as defined by the appended claims.

What is claimed is:

1. In client device, a method for transitioning a first environment of a client device to a second environment, comprising:
receiving, by the client device, a first disk image to create the first environment executed, and displayed to an end-user, by the client device and a second disk image to create the second environment executed by the client device;
identifying, by the client device, a change to the first environment;
updating, by the client device, the second environment with the identified change to the first environment; and
swapping, by the client device, the second environment with the first environment, the second environment displayed to the end-user by the client device.

2. The method of claim 1, wherein:
identifying the change to the first environment comprises recording, by the client device, at least one task related to a system event associated with the client device into an action log; and
updating the second environment with the identified change to the first environment comprises updating, by the client device, the second environment with the at least one task related to the system event from the action log.

3. The method of claim 2, wherein:
recording the at least one task related to the system event associated with the client device into the action log comprises recording, by the client device, an input/output event related to the client device into the action log; and
updating the second environment with the at least one task related to the system event from the action log comprises updating, by the client device, the second environment with the input/output event from the action log.

4. The method of claim 2, wherein:
recording at least one task related to the system event associated with the client device into the action log comprises recording, by the client device, a user-interface event related to the first environment into the action log; and
updating the second environment with the at least one task related to the system event from the action log comprises updating, by the client device, the second environment with the user-interface event from the action log.

5. The method of claim 4, wherein updating the copy environment with the user-interface event from the action log to generate the second environment comprises:
applying, by the client device, a user-interface event from the action log to the second environment to generate an updated second environment;
comparing, by the client device, the updated second environment to the first environment executed by the client device; and
in response to detecting a lack of correspondence between the updated second environment and the first environment, repeating, by the client device, the steps of:
applying, by the client device, a subsequent user-interface event from the action log to the copy environment to generate a subsequent updated second environment, and
comparing the subsequent updated second environment to the first environment executed by the client device.

6. The method of claim 2, wherein updating the second environment with the at least one task related to the system event from the action log comprises:
identifying, by the client device, the at least one task related to the system event from the action log as being a replayable task or a skippable task; and
updating, by the client device, the second environment with the replayable task related to the system event from the action log.

7. The method of claim 1, further comprising:
applying, by the client device, a software update to the second disk image to generate a patched disk image;
testing, by the client device, functional operation of the second environment; and
in response to detecting functional operation of the second environment, updating, by the client device, the second environment with the identified change to the first environment.

8. The method of claim 1, comprising:
executing, by the client device, a first instance of an application within the first environment and a second instance of the application in the second environment;
creating, by the client device, a first visual copy of the first instance of the application executed by the client device in the first environment;
identifying the change to the first environment comprises identifying, by the client device, a change to the first instance of the application executed by the client device based upon a comparison of the first visual copy of the application executed by the client device in the first environment and a second visual copy of the application executed by the client device in the first environment;
updating the copy environment with the identified change to the first environment to generate a second environment comprises:
generating, by the client device, a task list identifying one or more steps to transition the second instance of the application to the first instance of the application, and
applying, by client device, the one or more steps of the task list to transition the second instance of the application to a transitioned second instance of the application; and
swapping the second environment with the first environment, the second environment displayed to the end-user by the client device comprises swapping, by the client device, the transitioned second instance of the application as the replacement for the first instance of the application.

9. The method of claim 1, further comprising:
tracking, by the client device, operation of the second environment; and
in response to detecting a failure of operation of the second environment, replacing, by the client device, the second environment with the first environment.

10. The method of claim 1, wherein the second environment is configured as a functional equivalent to the first environment such that the second environment operates with a core functionality corresponding to a core functionality of the first environment.

11. A client device, comprising:
a controller having a processor and a memory, the controller configured to:
receive a first disk image to create the first environment executed, and displayed to an end-user, by the client device and a second disk image to create the second environment executed by the client device;
identify a change to the first environment;
update the second environment with the identified change to the first environment; and
swap the second environment with the first environment, the second environment displayed to the end-user by the client device.

12. The client device of claim 11, wherein:
when identifying the change to the first environment, the controller is configured to record at least one task related to a system event associated with the client device into an action log; and
when updating the second environment with the identified change to the first environment the controller is configured to update the second environment with the at least one task related to the system event from the action log.

13. The client device of claim 12, wherein:
when recording the at least one task related to the system event associated with the client device into the action log the controller is configured to record an input/output event related to the client device into the action log; and
when updating the second environment with the at least one task related to the system event from the action log the controller is configured to update the second environment with the input/output event from the action log.

14. The client device of claim 12, wherein:
when recording at least one task related to the system event associated with the client device into the action log, the controller is configured to record a user-interface event related to the first environment into the action log; and
when updating the second environment with the at least one task related to the system event from the action log, the controller is configured to update the second environment with the user-interface event from the action log.

15. The client device of claim 14, wherein when updating the copy environment with the user-interface event from the action log to generate the second environment, the controller is configured to:
apply a user-interface event from the action log to the second environment to generate an updated second environment;
compare the updated second environment to the first environment executed by the client device; and
in response to detecting a lack of correspondence between the updated second environment and the first environment, repeat the steps of:
applying a subsequent user-interface event from the action log to the copy environment to generate a subsequent updated second environment, and
comparing the subsequent updated second environment to the first environment executed by the client device.

16. The client device of claim 11, wherein when updating the second environment with the at least one task related to the system event from the action log the controller is configured to:
identify the at least one task related to the system event from the action log as being a replayable task or a skippable task; and
update the second environment with the replayable task related to the system event from the action log.

17. The client device of claim 11, wherein the controller is further configured to:
apply a software update to the second disk image to generate a patched disk image;
test functional operation of the second environment; and
in response to detecting functional operation of the second environment, update the second environment with the identified change to the first environment.

18. The client device of claim 11, wherein the controller is configured to:
execute a first instance of an application within the first environment and a second instance of the application in the second environment;
create a first visual copy of the first instance of the application executed by the client device in the first environment;
when identifying the change to the first environment identify a change to the first instance of the application executed by the client device based upon a comparison of the first visual copy of the application executed by the client device in the first environment and a second visual copy of the application executed by the client device in the first environment;
when updating the copy environment with the identified change to the first environment to generate a second environment:
generate, a task list identifying one or more steps to transition the second instance of the application to the first instance of the application, and
apply the one or more steps of the task list to transition the second instance of the application to a transitioned second instance of the application; and
when swapping the second environment with the first environment, the second environment displayed to the end-user by the client device, swap the transitioned second instance of the application as the replacement for the first instance of the application.

19. The client device of claim 11, wherein the controller is further configured to:
track operation of the second environment; and
in response to detecting a failure of operation of the second environment, replace the second environment with the first environment.

20. The client device of claim 11, wherein the second environment is configured as a functional equivalent to the first environment such that the second environment operates with a core functionality corresponding to a core functionality of the first environment.
